(19) United States
(12) Patent Application Publication
(10) Pub. No.: US 2015/0188208 A1
(43) Pub. Date: Jul. 2, 2015

(54) BAND-PASS FILTER

(71) Applicants: Institute of Physics, Chinese Academy of Sciences, Beijing (CN); Beijing Huarong Tianchuang Superconduct Technology Development Co., Ltd., Beijing (CN); University of Science and Technology Beijing, Beijing (CN); O.Ya. Usikov Institute for Radiophysics and Electronics, National Acad of Sciences of Ukraine, Kharkiv (UA)

(72) Inventors: Liang SUN, Beijing (CN); Xu Wang, Beijing (CN); Jia Wang, Beijing (CN); Yun Wu, Beijing (CN); Yusheng He, Beijing (CN); Hong Li, Beijing (CN); Jiangming Huang, Beijing (CN); Sheng Luo, Beijing (CN); Valerii Skresanov, Kharkiv (UA); Oleksandr Barannyk, Kharkiv (UA); Volodymyr Glamazdin, Kharkiv (UA); Volodymyr Zolotarev, Kharkiv (UA); Myhaylo Natarov, Kharkiv (UA); Mykola Cherpak, Kharkiv (UA); Oleksandr Shubnyj, Kharkiv (UA)

(21) Appl. No.: 14/581,483

(22) Filed: Dec. 23, 2014

(30) Foreign Application Priority Data
Dec. 26, 2013 (UA) A 2013 15299

(51) Int. Cl. H01P 1/20

(52) U.S. Cl. CPC H01P 1/2002

(57) ABSTRACT

Band-pass filter having a body comprising a rectangular waveguide and a dielectric insert comprising a dielectric plate and a high temperature superconductive film in line with a number of rectangular windows of the same height. The waveguide has a×b cross-section, a being length of the wide wall and b the length of the narrow wall. Each wide wall has a fixing groove at the central portion and a rectangular recess in the fixing groove. The dielectric plate has two ends in the fixing grooves and is symmetric with a perpendicular bisecting plane of the wide wall. The rectangular recess is symmetric to the perpendicular bisecting plane and has same length as the waveguide, with its width w satisfies t<w<a/2, and depth d satisfies d<λ/4, t being total thickness of the dielectric plate and the high temperature superconductive film, and λ the wavelength of the central frequency of the pass-band of the band-pass filter.

### CROSS-REFERENCE TO RELATED APPLICATION

The subject application claims the benefit of Ukrainian Patent Application No. a 2013 15299 filed on Dec. 26, 2013 in the Patent Office of Ukraine, the whole disclosure of which is incorporated herein by reference.

### BACKGROUND OF THE INVENTION

1. Field of the Invention

The present invention relates to the microwave technique, particularly, a band-pass filter which can be used in cryo-electronic units at the front end of a receiver used in radio telescopes and satellite communication lines.

2. Description of the Related Art

Band-pass filters that are installed at the input of low-noise amplifiers (LNA) are designed to provide electromagnetic compatibility of radio electronic facilities, i.e., to protect input circuits of a highly sensitive receiver from electromagnetic radiation outside the operating bandwidth. Currently, transistor LNA are widely used and replace the previously developed parametric and quantum amplifiers because of their lower noise temperature, broad bandwidth and operational advantages (stability, efficiency and ability to operate at cryogenic temperature). The main characteristic of highly sensitive receivers is the equivalent noise temperature T_{R} of the receiver, which is mainly determined by the noise temperature T_{A} of the LNA and noise temperature T_{F} of passive circuit at the input of LNA (for example, a band-pass filter), that is, T_{R}=T_{F}+T_{A}. To decrease T_{R} the transistor LNA is cooled to cryogenic temperatures. Noise temperature of the band-pass filter depends on its physical temperature T₀ and insertion loss L_{dB}. In the case of low insertion loss (L_{dB}<0.5 dB) noise temperature of the band pass filter is defined by a simple formula: T_{F}=(L_{dB}/4.34)T₀ [Siegman A. E. Microwave Solid-State Masers/New York-San Francisco-Toronto-London: McGraw-Hill Book Company, 1964]. For an element with a insertion loss of 0.1 dB, the noise temperature is 7 K at an operation temperature of 300 K, and the noise temperature is decreased to 1.4K at an operation temperature of 60K. Therefore, advantage of decreasing the temperature of the front end of the receiver is obvious. The smaller the insertion loss L_{dB} of the band-pass filter is, the lower the noise temperature T_{F} is. It follows that band-pass filters, made of materials with high conductivity or low value of the microwave surface resistance R_{S}, have advantage. This is why high-temperature superconductivity (HTS) materials are used in the design of the band-pass filter. Further, the value R_{S} of HTS materials is lower than R_{S} of normal metals by several orders, and, on the other hand, the HTS materials go over a superconductive state at a cryogenic temperature of or lower than the temperature of liquid nitrogen (about 77 K), and hence reliable and economical cryo-coolers can be used in the cryo-electronic unit of receiver. Currently, the technology of HTS materials has reached a high level such that they can be used in technical devices. The invention provides a band-pass filter, which uses HTS material in a form of HTS film deposited on the side surface of the dielectric plate (substrate) with low dielectric losses (e.g., superconductive layers of YBaCuO on MgO substrate).

Multi-pole band-pass filters with the so-called E-plane metal insert in a rectangular waveguide are well known [Vahldieck R., Bornemann J., Arndt F., Graueryolz D. Optimized Waveguide E-Plane Metal Insert Filters for Millimeter—Wave Applications//IEEE Trans. Microwave Theory Tech. Vol. 31, No. 1, 1983, pp. 65-69]. In the E-plane of rectangular waveguide between the wide walls, a number of metal strips are installed, and regular rectangular waveguides are formed between the metal strips. The regular rectangular waveguides correspond to the resonators in the filter, and the resonators are coupled by means of two portions of the regular rectangular waveguide which are separated by the metal strips. End portions of the rectangular waveguide separated by the metal strips are elements of the filter for coupling with input and output transmission lines.

Band-pass filters called fin-line filters, which are based on the principles described above, were proposed. Instead of an E-plane metal insert, an E-plane dielectric insert is used in the filter. Metal strips of normal metal are applied to one or both side surfaces of the insert (see, e.g., [Arndt F., Bornemann J., Grauneryolz D., Vahldieck R. Theory and Design of Low-Insertion Loss Fin-Line Filters//IEEE Trans. Microwave Theory Tech. Vol. 30, No. 2, 1982, pp. 155-163]). Such designs have advantages in the millimeter wavelength range, because the photolithography technology of manufacture which allows maintaining the exact dimensions of metal strips, can be used.

The idea of using the inserts from HTS materials instead of fin-line inserts in the E-plane of band-pass filters was first expressed in the work [Mansour R. R., Zybura A. Superconductive Millimeter-Wave E-Plane Filters//IEEE Trans. Microwave Theory Tech. Vol. 39, No. 9, 1991, pp.1588-1492]. Experimental study of such a filter was carried out in the work [Liang Han, Yiyuan Chen, Yunyi Wang. Design and Performance of WaveguidevE-Plane HTSC Insert Filters/1992 IEEE MTT-S Digest, pp. 913-916]. The inventors investigated the characteristics of band-pass filter with E-plane insert of HTS material in comparison with the characteristics of band-pass filter with E-plane inserts of the normal metal [Skresanov V. N., Barannik A. A., Cherpak N. T., Y. He, Glamazdin V. V., Zolotaryov V. A., Shubny A. I., Sun L., Wang J., Wu Y./Experience in Developing Ka-Band Waveguide Filter with HTS E-Plane Insert/The 8-th International Kharkov Symposium on Physics and Engineering of Microwaves, Millimeter and Submillimeter Waves (MSMW'2013) Kharkov, Ukraine, June 23-28, 2013]. In particular, it was shown that the advantages of the band-pass filters with E-plane insert of the HTS material cannot be realized if the problem of providing high-quality contact between HTS insert and the waveguide walls is not solved. Contact area should have small losses of microwave power, ensure good thermal contact between the HTS insert and the waveguide walls and prevent the destruction of the fragile substrate plate in cooling-heating cycles of the filter. The closest analogue on the technical essence of the above pass-band filter is the pass-band filter which comprises a rectangular waveguide of a×b cross-section and a dielectric plate, on both surfaces of which high temperature superconductive films are placed, with a number of windows. Specifically, the windows are symmetric relative to a dissecting plane of the rectangular wave in the height direction, of the same height, different length and at different distances relative to each other. The dielectric plate is mounted in an axial plane perpendicular to the wide walls of the waveguide [Liang Han, Yiyuan Chen, Yunyi Wang. Design and Performance of WaveguidevE-Plane HTSC Insert Filters/1992 IEEE MTT-S Digest, pp. 913-916]. Lengths of rectangular windows, as well as the distances between them are calculated and both are different for different windows. These dimensions determine the Eigen frequencies of the resonators, coefficients of mutual coupling between the resonators and the coupling coefficient of the resonators with the transmission lines, which in turn are determined by the characteristics of the band-pass filter to be achieved.

The above pass-band filter is a natural development of the known band-pass filters with E-planar fin-line inserts, and can reduce insertion loss due to lower surface resistance R_{S} of microwave HTS materials compared to normal metals. Another mechanism of reducing the insertion loss, acting together with the mechanism described above, is redistributing of the microwave currents in the waveguide walls by means of the currents in the conductive surfaces of the insert after the dielectric insert is inserted into waveguide.

However, the achieving of these advantages has the following technical contradiction. One of the components of the insertion loss, i.e. the scattering of microwave power in contact area between the HTS films and the waveguide walls, should be small compared with the heat Joule loss in the HTS films. In the above band-pass filter, it can be achieved if the surface of the filter housing is polished and thus mechanically in close contact with the HTS films of insert. The dielectric plate (substrate) should be made of materials with low dielectric losses and a crystal lattice close to the crystal structure of the HTS film. Some single crystal dielectrics, such as MgO, LaAlO₃, and Al₂O₃, have such properties. However, the specified dielectrics are fragile and are easy to be destroyed in cooling-heating cycles of filter when the specified dielectrics are in close mechanical contact with the filter body. Destruction problem is not solved, even if the filter body is made of a material with a coefficient of linear expansion close to that of a dielectric plate (for example, the filter body is made of titanium, while the substrate is made of MgO. The reason is that temperature gradients caused during cooling in the filter body introduce unacceptable mechanical stresses in the dielectric plate.

### SUMMARY OF THE INVENTION

The present invention has been made to overcome or alleviate at least one aspect of the above mentioned disadvantages.

According to an exemplary embodiment of the present invention, a band-pass filter is provided. The filter comprises a body; a rectangular waveguide defined in the body and of a×b cross-section, wherein a is the length of a wide wall of the waveguide, b is the length of a narrow wall of the waveguide, and each wide wall is provided at a central portion thereof with a fixing groove; and a dielectric insert, two ends of which are placed in the fixing grooves respectively and which is arranged to be symmetric with respect to a perpendicular bisecting plane of the wide wall,

wherein the dielectric insert comprises a dielectric plate and a high temperature superconductive film which is provided in line with a number of rectangular windows of the same height, wherein each wide wall is provided with a rectangular recess in which the fixing groove is formed, the rectangular recess is symmetric with respect to the perpendicular bisecting plane, the length of the rectangular recess is the same as that of the waveguide, the width w of the rectangular recess is less than a and is greater than a total thickness t of the dielectric plate and the high temperature superconductive film.

Alternatively, the depth d of the rectangular recess satisfies d<λ/4, wherein λ is a wavelength corresponding to a central frequency of pass-band of the band-pass filter.

Alternatively, the width w of the rectangular recess satisfies t <w<a/2.

Alternatively, a thermal conductive layer is provided between an inner wall of each fixing groove and an outer surface of a corresponding end of the dielectric insert placed thereinto, wherein the thermal conductive layer can deform to absorb deformation of the dielectric plate. Further, the thermal conductive layer comprises an indium foil.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view of a band-pass filter according to an exemplary embodiment of the present invention.

FIG. 2 is a cross-section of a waveguide in the band-pass filter in FIG. 1.

FIG. 3 is a cross-section of the band-pass filter in FIG. 1 in an axial plane of the waveguide perpendicular to the wide wall of the rectangular waveguide.

FIG. 4 is a schematic view showing a CST model of coupled resonators in the band-pass filter according to an exemplary embodiment of the present invention.

FIG. 5 shows an example of S-parameters of the coupled resonators in the band-pass filter.

FIG. 6 shows the dependences of S-parameters and frequency of an eight-pole band-pass filter.

FIG. 7 shows insertion loss of the eight-pole band-pass filter.

FIG. 8 shows the current distribution in the coupled resonators in band-pass filter with HTS insert in a rectangular waveguide.

FIG. 9 shows the current distribution in the coupled resonators of band-pass filter with HTS insert in the cross waveguide according to an exemplary embodiment of the present invention.

FIG. 10 shows dependence of loss in elements of band-pass filter on a depth of the rectangular recesses.

FIG. 11 shows the insertion losses of two two-pole band-pass filters with the same bandwidth equal to 250 MHz, wherein curve 1 corresponds to a band-pass filter with an E-plane copper insert in a rectangular waveguide at an operating temperature of 77K and curve 2 corresponds to a band-pass filter with E-plane HTS insert in the cross waveguide at an operating temperature of 77K.

### DETAILED DESCRIPTION OF PREFERRED EMBODIMENTS OF THE INVENTION

Exemplary embodiments of the present invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

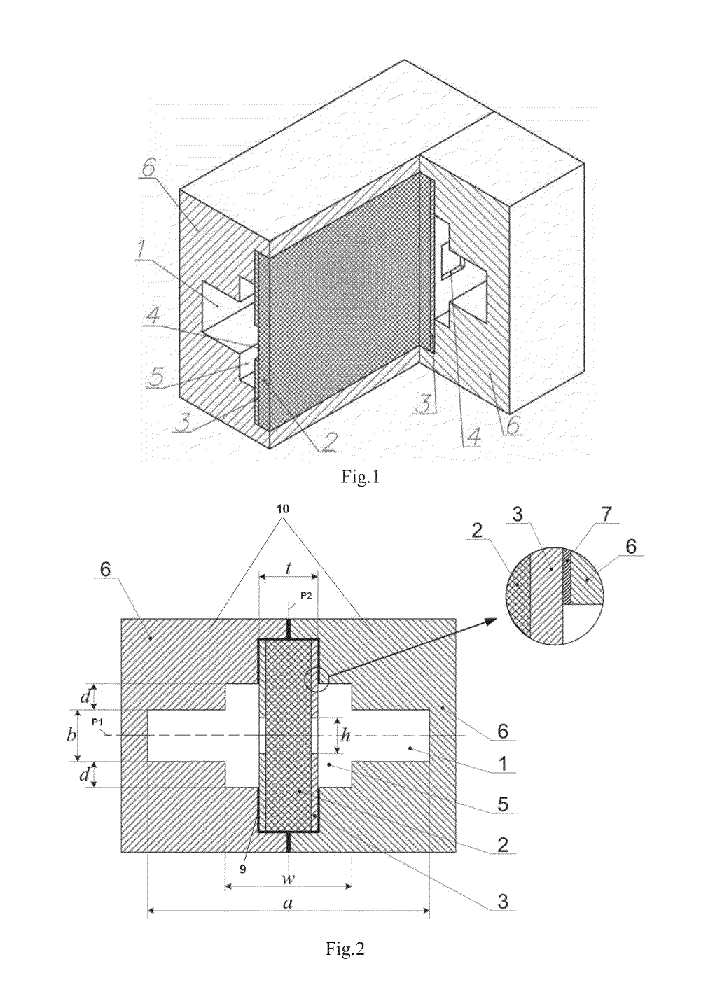

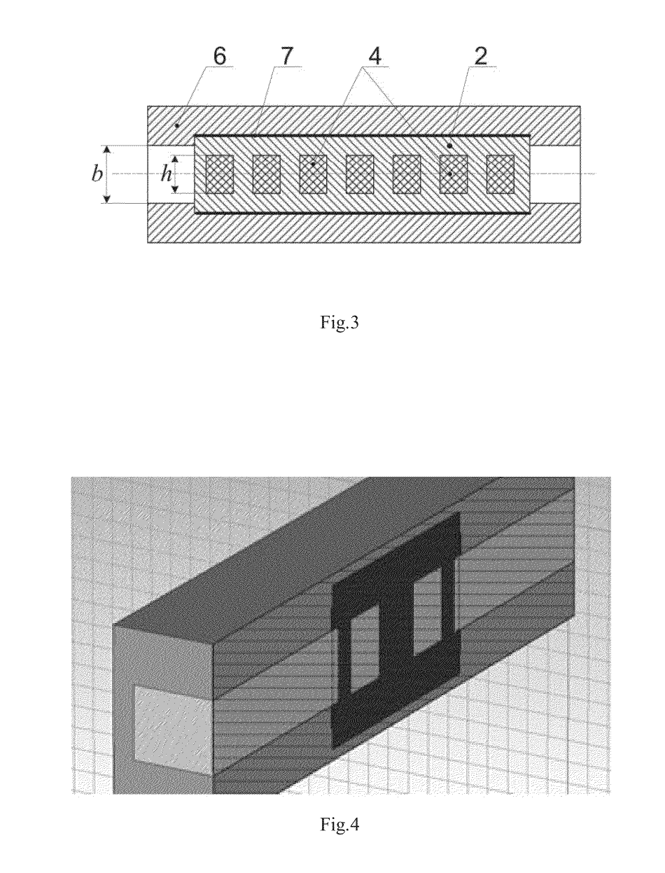

As shown in FIGS. 1 and 2, a band-pass filter comprises a rectangular waveguide 1 of a×b cross-section and a dielectric plate (or substrate) 2. Identical HTS films 3 with a number of windows 4 of the same height are placed symmetrically relative to a bisecting plane P1 of the rectangular waveguide in the height direction. The windows 4 have different lengths and are spaced from each other by different distances. Specific dimensions of the windows 4 are determined by the characteristics of band-pass filters, which should be designed. The dielectric plate 2 is mounted in a perpendicular bisecting plane P2 of the wide walls of the rectangular waveguide 1. The dielectric plate 2 with the HTS films 3 and the rectangular windows 4 will be called hereinafter HTS insert.

As shown in FIGS. 1 and 2, rectangular recesses 5 of length equal to the length of the HTS insert are cut in both wide walls of the rectangular waveguide 1 along its axis direction of the rectangular waveguide 1. The rectangular recesses 5 are symmetrical with respect to the perpendicular bisecting plane P2. The HTS insert is fixed at the bottoms of the rectangular recesses 5 by means of fixing grooves 9.

The HTS film 3 may be provided only at one side of the dielectric plate 2.

Thus, the present invention provides a band-pass filter, comprising a body 10; a rectangular waveguide 1 defined in the body 10 and of a×b cross-section, wherein a is the length of a wide wall of the waveguide 1, b is the length of a narrow wall of the waveguide 1, and each wide wall is provided at a central portion thereof with a fixing groove 9; and a dielectric insert, two ends of which are placed in the fixing grooves 9 respectively and which is arranged to be symmetric with respect to a perpendicular bisecting plane P2 of the wide wall, wherein the dielectric insert comprises a dielectric plate 2 and a HTS film 3 which is provided in line with a number of rectangular windows 4 of the same height,

wherein each wide wall is provided with a rectangular recess 5 in which the fixing groove 9 is formed, the rectangular recess 5 is symmetric with respect to the perpendicular bisecting plane P2, the length of the rectangular recess is the same as that of the waveguide 1, the width w of the rectangular recess 5 is less than a and is greater than a total thickness t of the dielectric plate 2 and the HTS film.

One way of fixing the dielectric plate 2 is to clamp the HTS insert between two identical half-bodies 6 forming the body 10. Surface profiles of the half-bodies 6 are made so that, after pressing the half-bodies together, both the rectangular waveguide 1 and the rectangular recesses 5 are formed. The rectangular waveguide 1 with the recesses in wide walls is often referred to cross waveguide in the literature [Tham Q. C. Modes and Cutoff Frequencies of Crossed Rectangular Waveguides/IEEE Trans. Microwave Theory Tech. Vol. 25, No. 7, 1977, pp. 585-588]. In order to form reliable thermal contact between the HTS insert and the half-bodies, it is desirable to interlay a thin thermo-conducting layer 7, for example, of indium foil, between mating surfaces of the HTS insert and the half-bodies. In the invention, loss of microwave energy in the layer 7 is very small even the layer 7 has a low conductivity. At the same time, the layer 7 will eliminate mechanical stresses in a dielectric plate 2 during cooling-heating cycles of the band-pass filter and thereby prevent the dielectric plate 2 from being damaged. The thermo-conducting layer 7 may have good ductibility or elasticity at cryogenic temperature so as to absorb the deformation of the dielectric plate 2. As mentioned above, the thermo-conducting layer 7 may be made of indium foil.

Geometric dimensions of the rectangular recesses depend on the thickness t and electro-physical characteristics of the HTS insert. The depth d of the rectangular recess should be large enough, further, the depth d should not exceed one-quarter of a wavelength (central wavelength of filter bandwidth) corresponding to a central frequency of the pass band of the filter, and further, the recess width w is in the range of t<w<a/2 . The height h of the windows 4 is determined primarily by conductivity of HTS material, and may lie in the range of b/2<h<b.

The principle of operation of the proposed filter with E-plane HTS insert in cross-waveguide is similar to the principle of operation of the filter with E-plane HTS insert in rectangular waveguide, and the differences therebetween lie in methods of electro-magnetic analysis of the filters, as well as the ability to improve the filter performance.

The most effective method of electro-magnetic analysis of the band-pass filters with the required technical characteristics (bandwidth, the level of return losses and the slopes) is to pay more attention to key characteristics, and then to get, based on the key characteristics, scattering matrixes satisfying the key characteristics. During the initial stage of the design, based on the scattering matrixes, a so-called filter-prototype is calculated and obtained by establishing an equivalent circuit mode. Then, a parameter function which depends on the geometry structure of the band-pass filter is established based on the required technical characteristics, and finally the required technical characteristics are met by optimizing the geometry structure of the band-pass filter.

Now the filters with E-plane metal inserts or fin-line inserts in rectangular waveguide are designed in accordance with above presented method, see, e.g., [Vahldieck R., Bornemann J., Arndt F., Grauerholz D.//Optimized Waveguide E-Plane Metal Insert Filters for Millimeter-Wave Applications. IEEE Trans. Microwave Theory Tech., Vol. 31, No. 1, pp. 65-69, 1983.] i [Arndt F., Bornemann J., Grauneryolz D., Vahldieck R. Theory and Design of Low-Insertion Loss Fin-Line Filters//IEEE Trans. Microwave Theory Tech. Vol. 30, No. 2, 1982, pp. 155-163]. In order to analyze the filters with E-plane inserts of fin-line type in a cross waveguide, it is necessary to know a complete set of Eigen functions of the electromagnetic field in the cross waveguide. Currently, the electromagnetic characteristics of the band-pass filter of the present invention may be analyzed by means of fitting method of solving Maxwell equations using CTS software.

During the first stage, a initial solution of a band-pass filter-prototype is calculated by means of theory of circuits, and parameters of the pass-band filter, i.e., number of poles of the filter, Eigen frequencies of the resonators of the filter, coefficients of mutual coupling of the resonators of the filter and external Q-factors Q_{EX} of the end resonators, are determined, see [J. L. Matthae, L. Young, E. M. T. Jones, Microwave Filters, Impedance-Matching Networks, and Coupling Structures-McGraw-Hill Co., 1968.].

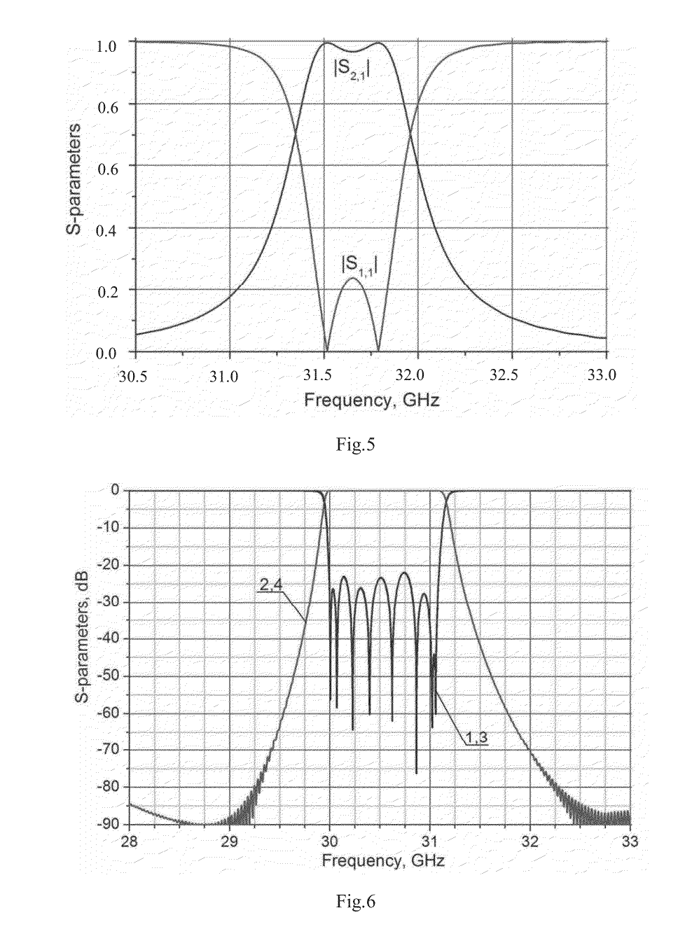

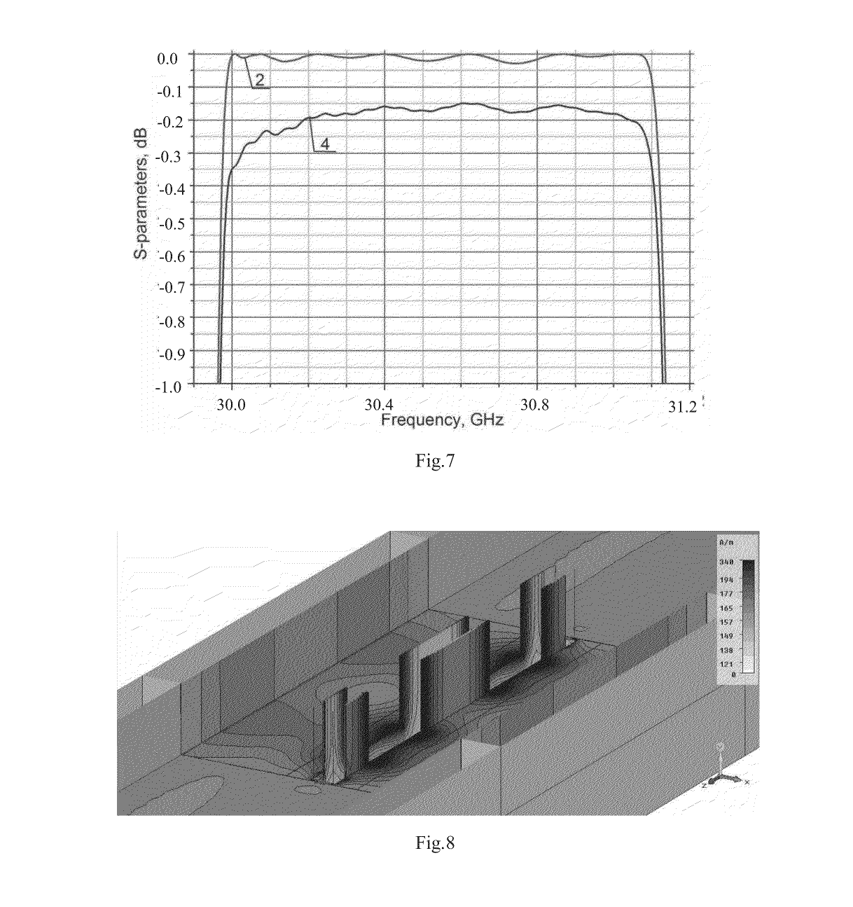

During the second stage, the initial values for the following parameters are given: (i) the resonator lengths (i.e. the window lengths), which determine Eigen frequencies of the resonators, (ii) the lengths of sections of mutual coupling (i.e. distance between the windows), which determine coefficients of mutual coupling of the resonators, and (iii) the lengths of the end sections of the rectangular waveguide coupling with input and output lines, which determine external Q-factors Q_{EX} of the end resonators (it is noted that values of the external Q-factors Q_{EX} are influenced also by dimensions of the cross-section of the rectangular recess). For this purpose, a CST model of coupled resonators is created as shown in FIG. 4, and a curve showing dependences between frequency and S-parameters is calculated, referring to the example presented in FIG. 5. Based on the S-parameter curve, the Eigen frequencies of the resonators and the mutual coupling coefficients of the resonators are calculated by means of a method of extracting S-parameters raised by the inventors, see [V. N. Skresanov, V. V. Glamazdin, N. T. Cherpak “The Novel Approach to Coupled Mode Parameters Recovery from Microwave Resonator Amplitude-Frequency Response”, European Microwave Conference. (EuMW 2011 Conference Proceedings). 9-14 Oct. 2011.-Manchester, UK.-EuMA.-2011.-pp. 826-829]. The parameters of the equivalent circuits and the parameters of the initial solution of the band-pass filter may be adjusted by changing the lengths of windows and distance therebetween. During the third stage, the CST model of the pass-band filter is created based on the model of the band-pass filter and the coupling model between the resonators created in the second stage. The lengths of resonators and distances therebetween may be further determined accurately by creating an objective function based on the specifictions or characteristics of the band-pass filter to be designed and by using an optimization gradient method of the CST software. FIGS. 6 and 7 show simulation results of an eight-pole filter, wherein curve 1 and curve 2 correspond to parameters of elements of the filter without losses. In FIGS. 6 and 7, characteristics of the filter are given as follows: a central frequency is 30.5 GHz, a pass-band on −3 dB level is 1.2 GHz, a pass-band on −70 dB level is not more than 3 GHz, and a return loss is not worse than 25 dB. Curves 3 and 4 in FIG. 6 and FIG. 7 show the frequency characteristics of the band-pass filter taking into account Joule loss in the elements of the band-pass filter at an operation temperature of 77K. During simulating, loss tangent of the MgO dielectric substrate tan δ=6.2·10⁻⁶, conductivity of the metal walls of the waveguide σ_{Ag}=5.56·10⁸ S/m and the equivalent conductivity of the HTS material σ_{HTS}=1.0·10¹⁰ S/m are set. The simulating results show that the expected insertion loss of the eight-pole filter does not exceed 0.2 dB. Approximately the same calculated result can be obtained for band-pass filter with an E-plane HTS insert in a rectangular waveguide, assuming no loss in the area of contact of HTS insert with the waveguide body. In practice, the losses in the area of contact of HTS insert with the waveguide body always exist.

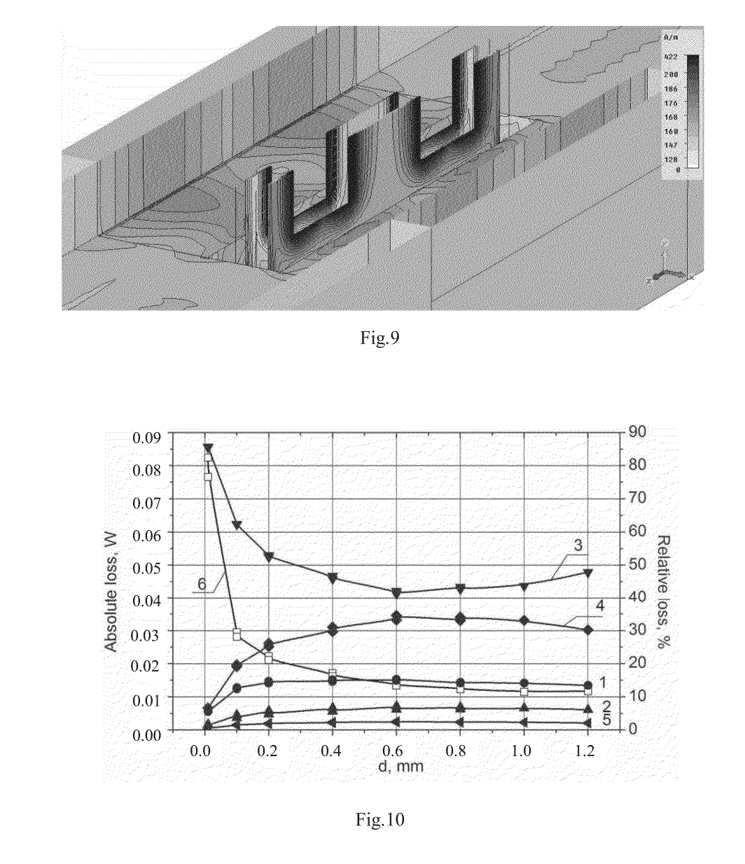

The rectangular recesses in the wide walls of the rectangular waveguide can reduce the losses in the contact region between the HTS insert and the waveguide to a negligible value. FIG. 8 and FIG. 9 show the distribution of surface currents in the waveguide walls, and the distribution of surface currents in the HTS layers of E-plane HTS inserts in a rectangular waveguide and in a cross waveguide, respectively. It is clearly seen that the current density at the contact region in the rectangular waveguide is much higher than the current density at the contact region in the cross waveguide. Consequently, for the same contact resistance, losses in the cross waveguide will be smaller.

A quantitative analysis may be carried out on this effect. FIG. 10 shows the dependence of the Joule losses in the various elements of the band-pass filter on the depth of the recesses. Obviously, in the special case for k=0, a cross waveguide is transformed into a rectangular waveguide. Losses are calculated in the horizontal and vertical walls of the waveguide (curves 1 and 2), in the HTS layers (curve 4), in the dielectric plate (curve 5) and finally in the contact regions (curve 3), assuming that the metal layers are of 0.05 mm thickness and have a poor conductivity (σ_{c}=1.0 10⁵ S/m). Relative losses in these elements of the band-pass filter are shown, taking 100% as the total loss for each case of the geometry, i.e., for each particular recess depth. In addition, the total loss for 1 W incident power is calculated for each filter geometry (curve 6).

It can be seen from FIG. 10 that with increasing of the depth of the recesses, the total loss initially decreases fast, and since a certain value (in this case d≈0.5 mm) the total loss remains approximately constant. This happens due to lower loss in the contact regions. For d>0.5 mm, the loss in the contact region is comparable with losses of other components.

Optimal sizes of rectangular recesses 5 for a given center frequency in the filter pass-band depend on the thickness of the dielectric plate 2 and the electro-physical characteristics of the HTS layers 3. As mentioned above, the optimum sizes of the recesses 5 are as follows: the recess depth d satisfies d<λ/4, where λ is the wavelength (central wavelength of filter bandwidth) corresponding to a central frequency of the pass band of the filter, and the recesswidth w satisfies t<w<a/2 , where t is the total thickness of the dielectric plate and HTS films.

In addition to reducing the losses in the contact regions by using a cross-waveguide, there is another mechanism to reduce losses, that is, to use HTS layers of lower surface resistance R_{S} or to use HTS layers of high equivalent conductivity σ_{HTS}. For example, σ_{HTS} is above 1.0×10¹² S/m when the frequencies are in centimeter and a longer-wavelength range. The inserting of the HTS insert causes the electro-magnetic files is concentrated more in the HTS layers and thus reduces the concentration of the field in the rest of the waveguide, in this case, the HTS insert corresponds to an open transmission line.

This transmission line is similar to a shielding slot line. With the decrease in the window height h, the electro-magnetic field is concentrated more in the resonators of HTS insert. Obviously, the higher the equivalent conductivity of HTS layers and the lower dielectric loss in the dielectric plate, the less the total electro-magnetic losses caused by the HTS insert. This effect may be reflected in the results by further imposing conditions on the height h of the windows.

The parameters that may affect the specifications or characteristics of the band-pass filter will be analyzed below. The insertion losses in the pass-band filter are determined by the relationship between Eigen Q-factor Q₀ and the external Q-factor Q_{EX} of the resonator of the filter. For a pair of coupled resonators, the following the formula (1) is satisfied, see [J. L. Matthae, L. Young, E. M. T. Jones, Microwave Filters, Impedance-Matching Networks, and Coupling Structures-McGraw-Hill Co., 1968]:

$$L = 20 lg ( \frac{1 + {Q}_{EX} / {Q}_{0}}{2 {kQ}_{EX}} + \frac{{kQ}_{EX}}{2} ) \qquad ( 1 )$$

where k is relative detuning of the normal frequencies of the coupled resonators. Eigen Q-factor Q₀ is inversely proportional to the insert loss, therefore, the insertion loss of the filter will decrease with HTS material with high equivalent conductivity, especially in the low-frequency part of the microwave range.

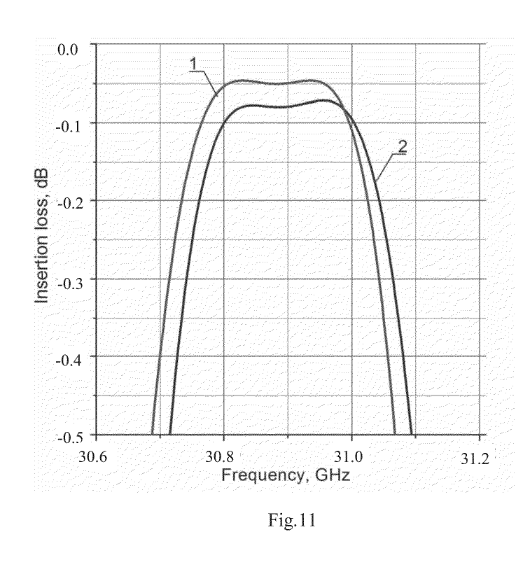

External Q-factor Q_{EX} determines the bandwidth. When reducing the bandwidth it is necessary to increase the external Q-factor Q_{EX}. This increases the ratio Q_{EX}/Q₀ and according to formula (1), the increasing of the ratio will increase the insertion loss. Therefore, the advantages achived by using the HTS insert will be more prominent for narrow-band filters. FIG. 11 shows the calculated insertion losses of two two-pole band-pass filters of Ka band and with a bandwidth of 250 MHz at the operation temperature of 77K, one of the two-pole band-pass filters has an E-plane copper insert in the waveguide thereof and the other of the two-pole band-pass filters has an E-plane HTS insert in the waveguide thereof. It can be seen that for the two-pole band-pass filter, the band-pass filter with the HTS insert gains ΔL₂=0.06 dB compared with the band-pass filter with the copper insert.

With the growing number of the filter poles, insert losses increase. Therefore the gain of introducing the HTS insert increases with the growing number of the filter poles. To evaluate the gain ΔLₙ for the multi-pole filter, the following formula (2) is used [J. L. Matthae, L. Young, E. M. T. Jones, Microwave Filters, Impedance-Matching Networks, and Coupling Structures-McGraw-Hill Co., 1968.]:

Lₙ[dB]≈8.69Cₙδ, (2)

where n is number of the filter poles; δ is attenuation rate of oscillations in the resonators of the filter; Cₙ is coefficient dependent on the number of poles of filter.

For the filter with Butterworth characteristics the following conditions are met: C₁=1.0; C₂=1.4; C₃=2.0; C₄=2.6; C₅=3.2; C₆=3.9; C₇=4.5; C₈=5.1. It can obtain the following formula (3) based on formular (2):

L₈[dB]=L₂(C_{8/}C₂)=3.64L₂. (3)

Formula (3) may be used for calculation of the loss increase. By substituting the numerical experiment value ΔL₂=0.06 dB (FIG. 11) into formula (3), it obtains ΔL₈=0.2 dB, which is a quite significant value. For even more narrow band-pass filters, the value will be even greater.

Thus, the use of band-pass filters with E-plane HTS inserts is advisable in cryo-electronic units of the microwave high-sensitive receivers that require narrow-band filters with steep fronts. The proposed technical solution of E-plane band-pass filter in comparison with the known solutions enables the gain in the insertion loss due to a reduction of loss in contact area between HTS insert and a waveguide body, and increases reliability of design due to eliminating the causes of destruction of dielectric substrate with HTS material.

Thus, the use of band-pass filters with E-plane HTS insert is advisable in cryo-electronic units of the microwave high-sensitive receivers that require narrow-band filters with steep fronts.

The proposed technical solution of E-plane band-pass filter in comparison with the known solutions enables the gain in the insertion loss due to a reduction of loss in the contact area between the HTS insert and the waveguide body. In addition, with the solution of the present invention, the reliability of the band-pass filter is increased due to eliminating the causes of destruction of dielectric substrate.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

We claim:

1. A band-pass filter, comprising:
a body;
a rectangular waveguide defined in the body, the waveguide having wide walls and narrow walls of a×b cross-section, wherein a is a length of the wide wall of the waveguide, b is a length of the narrow wall of the waveguide, and each wide wall is provided at a central portion thereof with a fixing groove; and
a dielectric insert having two ends, the two ends are placed in the fixing grooves respectively and are symmetric with a perpendicular bisecting plane of the wide wall, the dielectric insert further comprising a dielectric plate and a high temperature superconductive film line with a number of rectangular windows of a same height,
wherein each wide wall is provided with a rectangular recess, and in the rectangular recess, the fixing groove is formed; the rectangular recess is symmetric with the perpendicular bisecting plane of the wide wall, has a same length as the waveguide; and a width w of the rectangular recess is less than a and is greater than a total thickness t of the dielectric plate and the high temperature superconductive film.

2. The band-pass filter of claim 1, wherein a depth d of the rectangular recess satisfies d<λ/4, λ is a wavelength corresponding to a central frequency of a pass-band of the band-pass filter.

3. The band-pass filter of claim 1, wherein the width w of the rectangular recess satisfies t<w<a/2.

4. The band-pass filter of claim 2, wherein the width w of the rectangular recess satisfies t<w<a/2.

5. The band-pass filter of claim 1, wherein both sides of the dielectric plate are provided with the high temperature superconductive film.

6. The band-pass filter of claim 1, wherein the body is formed by two halves, and the two halves are symmetric with the perpendicular bisecting plane, and the two ends of the dielectric insert are held by the two halves.

7. The band-pass filter of claim 1, wherein a height h of the rectangular window satisfies b/2<h<b.

8. The band-pass filter of claim 1, further comprising
a thermal conductive layer between an inner wall of each fixing groove and an outer surface of a corresponding end of the dielectric insert placed thereinto,
wherein the thermal conductive layer is adaptable to deform to absorb deformation of the dielectric plate.

9. The band-pass filter of claim 8, wherein the thermal conductive layer comprises an indium foil.

10. The band-pass filter of claim 2, further comprising
a thermal conductive layer between an inner wall of each fixing groove and an outer surface of a corresponding end of the dielectric insert placed thereinto,
wherein the thermal conductive layer is adaptable to deform to absorb deformation of the dielectric plate.

11. The band-pass filter of claim 10, wherein the thermal conductive layer comprises an indium foil.

12. The band-pass filter of claim 3, further comprising
a thermal conductive layer between an inner wall of each fixing groove and an outer surface of a corresponding end of the dielectric insert placed thereinto,
wherein the thermal conductive layer is adaptable to deform to absorb deformation of the dielectric plate.

13. The band-pass filter of claim 12, wherein the thermal conductive layer comprises an indium foil.

14. The band-pass filter of claim 4, further comprising
a thermal conductive layer between an inner wall of each fixing groove and an outer surface of a corresponding end of the dielectric insert placed thereinto,
wherein the thermal conductive layer is adaptable to deform to absorb deformation of the dielectric plate.

15. The band-pass filter of claim 14, wherein the thermal conductive layer comprises an indium foil.
